(19) United States
(12) Patent Application Publication
(10) Pub. No.: US 2006/0242606 A1
(43) Pub. Date: Oct. 26, 2006

(54) Graphical roadmap view and framework for activity tracking and execution

(75) Inventor: Cheng-Yee Lin, Tualatin, OR (US)

Correspondence Address: CANADY & LORTZ - IBM, 2540 HUNTINGTON DRIVE, SUITE 205, SAN MARINO, CA, 91108, US

(73) Assignee: International Business Machines Corporation, San Jose, CA (US)

(21) Appl. No.: 11/114,636

(22) Filed: Apr. 26, 2005

(51) Int. Cl. G06F 9/00

(52) U.S. Cl. 715/855

(57) ABSTRACT

A method, apparatus and article of manufacture for providing a roadmap-like graphical view in a computer system that provides the user a global view of the actions for an activity and how they relate to one another in terms of execution. On an execution level the specifics on the actions are provided for the user to carry them out. In addition, a framework is also provided that can be converted into a standalone shareable component which any software application can use to create its own custom roadmaps. The roadmap framework need only be implemented once and then can be leveraged by many applications.

### BACKGROUND OF THE INVENTION

1. Field of the Invention

This invention relates to software applications. More specifically, this invention relates to software applications operating on a computer system for performing multiple categories of related activities through the execution of a plurality of actions.

2. Description of the Related Art

As software technology advances, software applications become capable of handling a wider variety of activities, and are loaded with much more functionality than before. A single software application usually encompasses several categories of related activities so that its users can choose and perform some of them. For example, in the business world, a typical tax planning/reporting software application may allow the user to report the tax return for the previous years, calculate the estimate tax for the current quarter, and analyze the trend for better planning for the future quarters in addition to many other possible actions. Taking a second example from software development, a typical JAVA 2 Platform, Enterprise Edition (J2EE) development tool could support the development activities for both Enterprise JAVA BEAN (EJB) and Web Services. The Web Services development would allow the user to create, build, test, deploy, and manage the Web Services, and the EJB development would support the user with a similar set of development activities for EJB.

In most conventional implementations, to perform a single activity with such software applications, the user must perform multiple sub-activities (or actions) in a particular sequence to attain the desired results. (Note that the terms, “sub-activity,” “action” and “sub-action,” are used interchangeably throughout the description; the prefix “sub” and the activity/action relation is used to define a relative relationship between parameters.) Following the software development example, while using the J2EE development tool, the user may decide to perform the Web Services development (which is considered an “activity”). The user would choose one of the several possible actions to create a Web service, and then the, user would need to take proper follow-up actions to build and test the service. Finally the user would choose one or more proper actions to deploy the service onto one or more servers where the service clients can actually use it.

With so many activities, their actions, and the sub-actions of those actions in a single application, it is becoming more difficult for the user to pick all the right tasks to accomplish what she wants to get done. Unless the user is experienced with the usage of a particular software application, the user is likely to run into a few challenges. In some cases, the software application may be used very infrequently and the user may not have the opportunity to become familiar with it. A few examples of this are found with on-line registration and licensing application systems for the Department of Motor Vehicles and college application systems for the high-school graduates.

There are many potential problems and difficulties that may arise in the use of a conventional software application. Here are some examples:
1. In many situations, the user knows what activity to perform, but she may not know how (and where in the application) to begin. Thus, it may be necessary for the user to expend excessive effort first learning how to use the application.
2. In general, an activity is performed by completing multiple actions within the application. The user may not know what all those actions are and may waste time on unnecessary actions irrelevant to the objective activity. However, with proper information of all those actions, the user would know all the requirements in advance and come up with a solid execution plan.
3. The user may know all the required actions, but she may not know the sequence in which to perform them. The user may perform some actions in the wrong order, and end up having to re-do those actions.
4. Some of the actions may result in different follow-up actions, depending on certain conditions. Those actions are not lined up in a single-threaded sequence, and may be in a few different paths that go through vastly different actions. Without knowing this, the user may proceed down the wrong path, and need to retract some of the actions and return to the right path.
5. As the user takes a particular action, she may not know where the current action is in relation to the other actions of the activity. With the proper information, the user would be able to come up with a better execution plan for managing the actions to complete the activity.
6. The activity may comprise several actions, and the user may only be able to complete some of them in a single session. In this case, the user would like to readily track of what actions have been taken, so she can continue on the rest at a later time.
   The current techniques and solutions for ameliorating these problems may be improved. Moreover, as software applications become more complex, these problems become more commonplace and the need for better solutions becomes more pressing.

It is important to provide the user necessary guidance to deal with these and other potential issues. Recalling the example of the Web Service development application, if the user does not know of the need or have the means for conducting tests of the Web service with the J2EE development tool before its deployment, she would have a difficult time grappling with service issues on the actual production server. Ultimately, this would also result in a degradation of the server performance as well.

Many current software applications use a sequence of dialogs (e.g. wizards) or questions-and-answers (e.g. in a one-on-one interview format) to help deal with many of the foregoing scenarios. For example, the integrated development environments (IDEs) tend to use wizards in creating new code projects and complex constructs, whereas the Web-based applications often use the interview-style questions to guide the users through a process. These approaches help alleviate some of the problems mentioned above and keep the user focused on a particular action at any given time. However, they do not provide the user with a global view of what the potential activities and actions are, as well as how they relate to one another in the “big picture”. The user would know about the action she is currently taking, but does not have a sense of what needs to be done next, or how many further actions she needs to perform to complete the entire activity.

Another class of the assistance features in conventional software applications is provided by a “task list view”. A task list view may be utilized when a software application executes a certain action, by adding the follow-up actions a view for the user. For example, the builder in the IDEs (e.g. MICROSOFT® VISUAL STUDIO®.NET or Eclipse) would show the errors in the task list view after the build so the user can take corrective actions on them. Nonetheless, the entries in the task list view are not organized with respect to their inter-dependencies, and usually include only the immediate follow-up actions. A task list view can be effective in handling bulk-volume, simple actions, but would be difficult to provide guidance on more complex, higher-level actions.

Besides the applications themselves, there are often white papers and technical articles that would help the user deal with these issues. However, they are not directly tied to the user gestures and the features within the applications, and tend to cover only specific example scenarios much simpler than real-world problems. They provide satisfactory overviews of the applications, but provide little help once the user gets into the details of more complex areas.

There may be some process-oriented applications that provide some types of workflow views, e.g. software applications for manufacturing or processing facilities. For example, in an on-line procurement system for a company, the flow of the entire procurement process may include creating a purchase request, passing the request through the management chain for approval, assigning the request to a buyer upon approval, sending a purchase order to the vendor, and verifying the actual reception of the purchased item. Since each company has its own processes, the supporting application would be created specifically for the process. However, the implementations for those workflows are largely hard-coded with the specifics of the workflows, making them inapplicable for reuse in other applications. Thus, such workflow views are not implemented with a generic framework for general application.

In view of the foregoing, there is a need in the art for software assistance tools which address these issues and problems. Particularly, there is a need to provide a software application user with a “big picture” view to guide the user through the actions for a complex activity of the software application. There is also a need for a framework for such a view that several different applications can readily utilize. As detailed hereafter, these and other needs are met by the present invention.

### SUMMARY OF THE INVENTION

Embodiments of the invention implement a roadmap-like graphical view that, on the global level, provides the user a broad view of the actions for an activity and how they relate to one another in terms of execution. On an execution level, embodiments of the invention provide the specifics of the actions for the user to carry them out.

Compared to previously known solutions (e.g. wizards, question-and-answer applets, and task list views), embodiments of the present invention allow a user to readily see what “roads” she can take to complete an activity on the graphical roadmap view while maintaining understanding of the individual actions and their execution sequence on the “road” she chooses to use without losing sight on the individual actions themselves.

A typical embodiment of the invention comprises a computer program embodied on a computer readable medium, including program instructions for displaying a graphical roadmap view for completing an activity comprising a plurality of actions, showing the plurality of actions as a plurality of nodes and program instructions for displaying a relationship among the plurality of actions as directed links interconnecting the plurality of nodes. The program instructions for displaying the graphical roadmap view comprise a generic framework with a shareable component operable with a plurality of client software applications. The client software applications perform activities, each activity comprising plurality of actions. The activity may also include at least one decision point among the plurality of actions such that the graphical roadmap view shows the decision point as a decision point node interconnected with the directed links to the plurality of nodes.

The shareable component of the generic framework may include a windowing functionality subcomponent for implementing windowing operations of the graphical roadmap view, a roadmap diagram engine subcomponent for rendering diagrams in the graphical roadmap view, a roadmap diagramming utility subcomponent for providing diagramming support including default visual indicators for the graphical roadmap view and a menu command manager subcomponent for registration, enabling and disabling of menu commands and communicating commands among subcomponents and the software application.

Convenient user navigation through the roadmap view may be provided. Accordingly, further embodiments of the invention may include program instructions for expanding the graphical roadmap view of a selected node of the displayed plurality of nodes to display additional nodes representing sub-actions corresponding to performing a corresponding action of the selected node.

The graphical roadmap view is a visual tool to facilitate efficient operation of the software application by the user. Thus, embodiments of the invention may include program instructions for displaying a visual indicator (e.g. associated with a node) corresponding to a state of each of the plurality of actions. The state may comprise a completion status of an associated action. The visual indicator may be a color, a pattern, a symbol or an animation or any other indicator allowing a user to distinguish among the actions. Further embodiments of the invention may also include program instructions for displaying an individual description for each of the plurality of actions. The individual description may be displayed upon selection by the user of a corresponding node among the plurality of nodes. In addition, the graphical roadmap view may be presented as a mode-less sub-window of the software application.

The graphical roadmap view may provide convenient functionality to facilitate tracking, planning and/or execution of the actions associated with completing the activity. Thus, embodiments of the invention may further comprise program instructions for providing context menus for each of the nodes where the context menus provides a group or list of functions including: displaying detailed information on a selected action, directing a user how to complete a selected action, completing a selected action and/or changing a completion status of a selected action.

Embodiments of the invention also encompass a method comprising displaying a graphical roadmap view for completing an activity comprising a plurality of actions, showing the plurality of actions as a plurality of nodes and displaying a relationship among the plurality of actions as directed links interconnecting the plurality of nodes. Displaying the graphical roadmap view is performed with a generic framework having a shareable component operable with a plurality of client software applications. The client software applications perform activities, each activity comprising plurality of actions. The method may be further modified consistent with the computer program embodiments described above.

In addition, because embodiments of the invention comprise a generic framework with a shareable component operable with a plurality of client software applications, any software application may use it to create one or more of its own custom graphical roadmap views. This allows the reuse of the generic framework across multiple applications. Thus, the roadmap framework itself need only be implemented once, and then can be leveraged by many applications.

### BRIEF DESCRIPTION OF THE DRAWINGS

Referring now to the drawings in which like reference numbers represent corresponding parts throughout:

FIG. 1 is a block diagram of a hardware environment suitable for implementing embodiments of the invention;

FIG. 2 shows a graphical roadmap view of the exemplary “Build J2EE Application” activity;

FIG. 3 shows the graphical roadmap view expanded for the exemplary “Build Web Service” action shown in FIG. 2;

FIG. 4 shows an example of an individual description of a selected action;

FIG. 5 illustrates an example of a visual indicator showing coloring that denotes the state of the actions;

FIG. 6 shows an example of a context menu provided for an action;

FIG. 7A illustrates an architectural view of a generic framework within a shareable component and how it interacts with its client, the application that employs the roadmap views;

FIG. 7B illustrates a graphical roadmap view operating with a software application; and

FIG. 8 is a flowchart of an exemplary method of providing a graphical roadmap view.

### DETAILED DESCRIPTION OF THE PREFERRED EMBODIMENT

In the following description of the invention, which includes a description of the preferred embodiment, reference is made to the accompanying drawings which form a part hereof, and in which is shown by way of illustration specific embodiments in which the invention may be practiced. It is to be understood that other embodiments may be utilized and structural changes may be made without departing from the scope of the present invention.

1. Hardware Environment

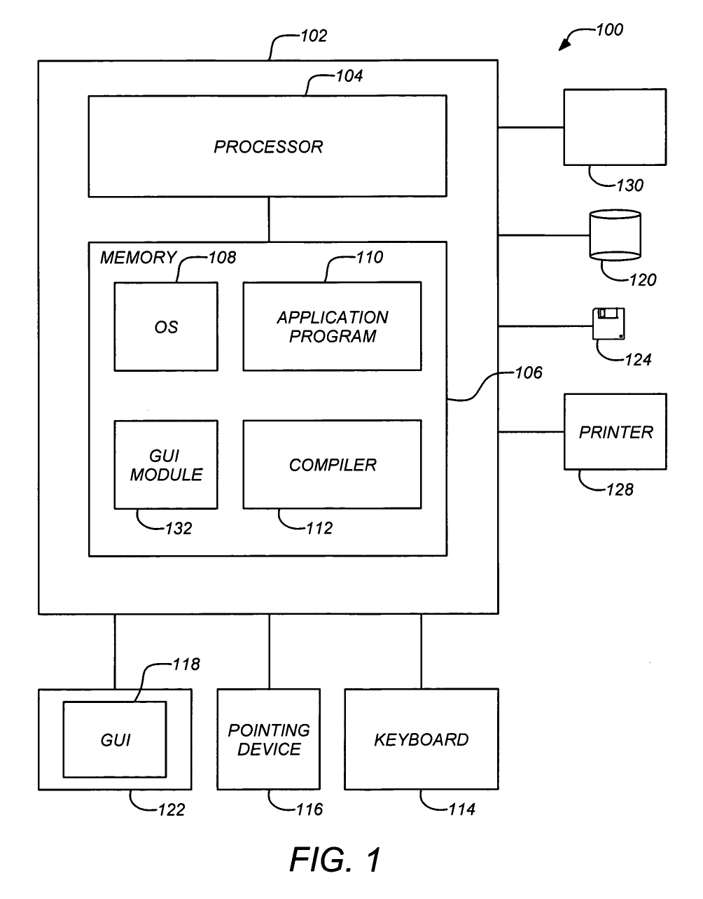

FIG. 1 illustrates an exemplary computer system 100 that can be used to implement selected modules and/or functions of the present invention. The computer 102 comprises a processor 104 and a memory 106, such as random access memory (RAM). The computer 102 is operatively coupled to a display 122, which presents images such as windows to the user on a graphical user interface 118. The computer 102 may be coupled to other devices, such as a keyboard 114, a mouse device 116, a printer, etc. Of course, those skilled in the art will recognize that any combination of the above components, or any number of different components, peripherals, and other devices, may be used with the computer 102.

Generally, the computer 102 operates under control of an operating system 108 (e.g. OS/2, LINUX, UNIX, WINDOWS, MAC OS) stored in the memory 106, and interfaces with the user to accept inputs and commands and to present results, for example through a graphical user interface (GUI) module 132. Although the GUI module 132 is depicted as a separate module, the instructions performing the GUI functions can be resident or distributed in the operating system 108, the computer program 110, or implemented with special purpose memory and processors. The computer 102 also implements a compiler 112 which allows an application program 110 written in a programming language such as C++, JAVA, ADA, BASIC, VISUAL BASIC or any other programming language to be translated into code readable by the processor 104. After completion, the computer program 110 accesses and manipulates data stored in the memory 106 of the computer 102 using the relationships and logic that was generated using the compiler 112. The computer 102 also optionally comprises an external communication device 130 such as a modem, satellite link, ethernet card, or other device for communicating with other computers, e.g. via the Internet.

In one embodiment, instructions implementing the operating system 108, the computer program 110, and the compiler 112 are tangibly embodied in a computer-readable medium, e.g., data storage device 120, which could include one or more fixed or removable data storage devices, such as a zip drive, floppy disc 124, hard drive, DVD/CD-rom, digital tape, etc. Further, the operating system 108 and the computer program 110 comprise instructions which, when read and executed by the computer 102, cause the computer 102 to perform the steps necessary to implement and/or use the present invention. Computer program 110 and/or operating system 108 instructions may also be tangibly embodied in the memory 106 and/or transmitted through or accessed by the data communication device 130. As such, the terms “article of manufacture,” “program storage device” and “computer program product” as may be used herein are intended to encompass a computer program accessible and/or operable from any computer readable device or media.

Those skilled in the art will recognize many modifications may be made to this configuration without departing from the scope of the present invention. For example, those skilled in the art will recognize that any combination of the above components, or any number of different components, peripherals, and other devices, may be used with the present invention.

In general, embodiments of the invention encompass at least one of two aspects, presenting a graphical roadmap view of all the actions in the activity for a computer application or providing a framework for the roadmap view so that a specific computer application can use it as a standalone component through its application programming interface (API). Thus, embodiments of the invention may exist as a computer program 110 implemented within the hardware environment described above.

2. Graphical Roadmap View

The graphical roadmap view comprises a number of characteristics. The implementing application utilizes a GUI which presents the graphical roadmap as a window on the display device.

Typically, a software application employing an embodiment of the invention runs as a window (the main window) on the display. Inside the main window, there are several subwindows that can show various details of the application operation. A roadmap view is a mode-less subwindow that may be docked inside the main window or floating as a separate window alongside the main window.

The view provides a roadmap-like display of the actions, and the associated decision points, within an activity. The actions and decision points are represented as nodes, and their dependencies are represented as directed links. The actual presentation of the roadmap may be presented in a modeling/diagramming language such as the Unified Modeling Language (UML). However, the invention is not limited to presentations employing known modeling/digramming languages. Hereafter an exemplary embodiment of the invention shall be described with respect to a software development application. It is important to note that the example of a software development application is provided only to illustrate the invention and the present invention is not limited to any particular type of application. In a general sense, a typical embodiment merely includes program instructions for some type of software application for performing at least one activity comprising a plurality of actions.

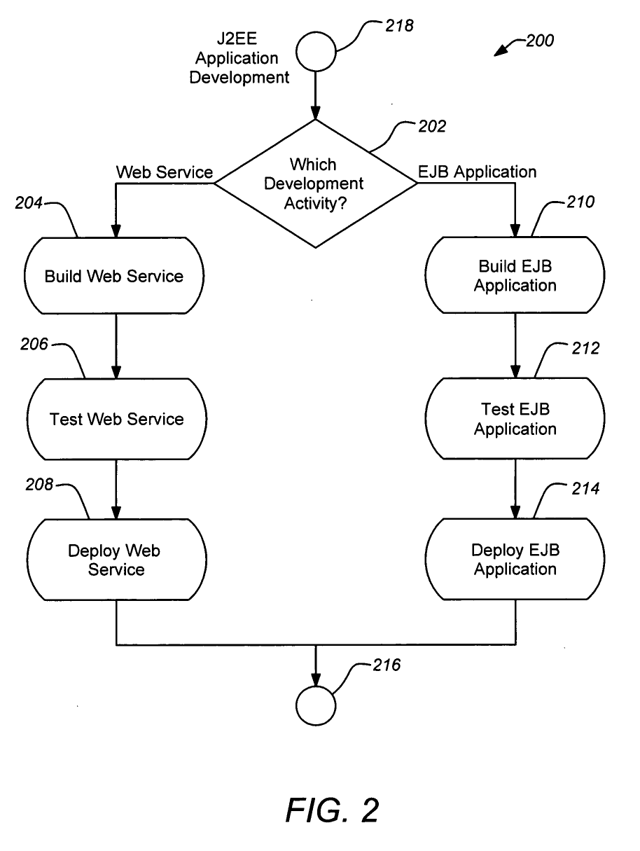

FIG. 2 shows a graphical roadmap view 200 of an exemplary “Build J2EE Application” activity. A UML activity diagram is used to provide an example representation of such a graphical roadmap view 200 in this description. The activity begins with a decision point node 202 from the start node 218 showing a selection between two possible development activities, a web service or an EJB application. The web service development activity comprises three actions shown by separate nodes in the roadmap view 200, the build web service node 204, the test web service node 206 and the deploy web service node 208 interconnected by directed links which indicate a prescribed sequence. The three nodes are shown in the roadmap view 200 in sequence. Similarly, the EJB application development activity comprises three actions shown by separate nodes in the roadmap view 200, the build EJB application node 210, the test EJB application node 212 and the deploy EJB application node 214 also interconnected by directed links which indicate a prescribed sequence. Both activities resolve at the same completion node 216. Thus, the graphical roadmap view 200 for completing an activity shows a plurality of actions represented as nodes 202-216 and a relationship among the actions as directed links interconnecting the nodes 202-216.

Since a typical action may comprise several sub-actions, the corresponding nodes may be expanded into several nodes in a new view where each of the several nodes represents a sub-action of the action. The graphical roadmap view 200 can be conveniently navigated by a user through expanding a view of a selected action. Thus, embodiments of the invention may include program instructions for expanding the graphical roadmap view of a selected node of the displayed plurality of nodes to display additional nodes representing sub-actions corresponding to performing the selected action.

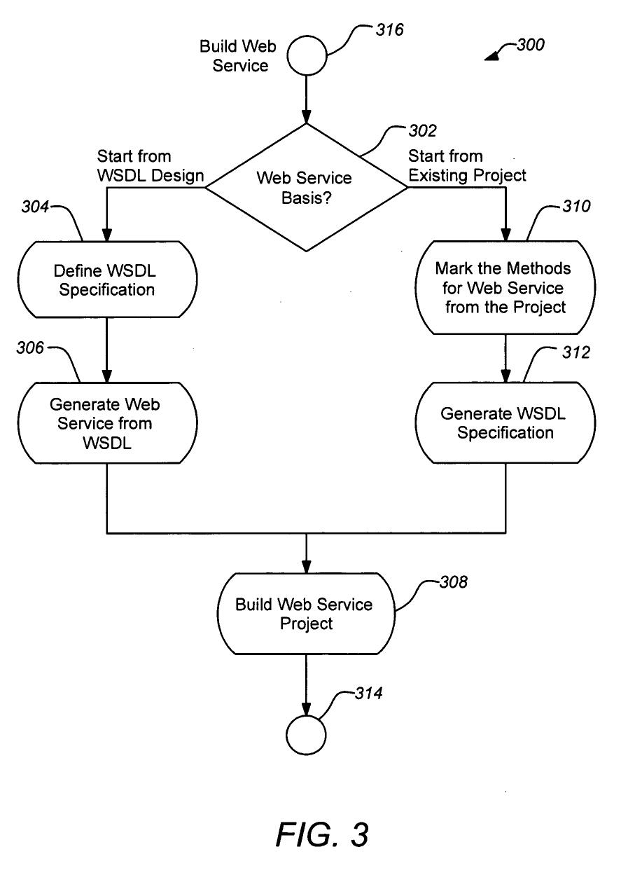

FIG. 3 shows an exemplary expanded graphical roadmap view 300 for the “Build Web Service” action in example of FIG. 2. The expanded graphical roadmap view 300 shows the sub-actions of the “Build Web Service” action represented by node 204 of FIG. 2. For example, this view 300 may be accessed by left-clicking a cursor on the node 204 of FIG. 2. The expanded view 300 shows a start node 316, representing the “Build Web Service” action, which has a directed link to a decision node 302 for determining what the basis for the desired web service will be, starting from a web service definition language (WSDL) design or starting from an existing project. If a WSDL start is desired, node 304 representing the sub-action of defining the WSDL specification and node 306 representing the sub-action of generating the web service from the WSDL specification are shown in sequence by interconnecting links. If the web service is started from an exisitng project, node 310 representing the sub-action of marking the methods for the web service from the project and node 312 representing the sub-action of generating the WSDL specification are shown in sequence by interconnecting links. In either case, both decision branches are then linked to nod 308 representing the sub-action of building the web service project before the completion node 314. Embodiments of the invention are not limited to a particular number of levels of expansion; sub-actions may also have associated expanded views (showing further detail “sub-sub-actions”) and so forth as desired. As described hereafter, many other functional enhancements may be implemented with the graphical roadmap view to facilitate efficient operation of the software application by the user.

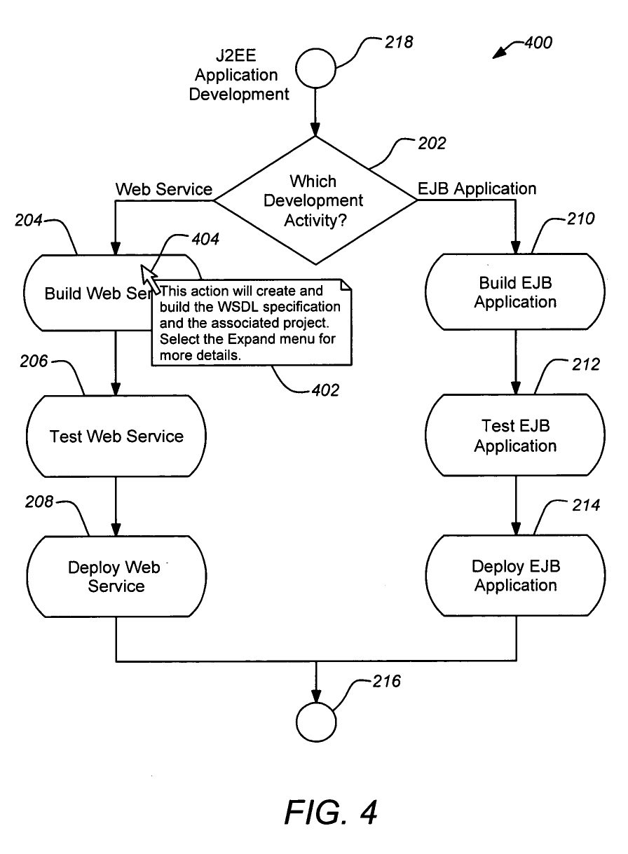

FIG. 4 shows an example of an individual description of a selected action. The nodes and/or directed links may be associated with brief individual descriptions of the corresponding actions, decisions, and dependencies (e.g., in the form of “tool tips”). Thus, embodiments of the invention may comprise program instructions for displaying an individual description of an associated action. The individual description of the associated action may be displayed upon selection of a corresponding node among the plurality of nodes. In the example application, the invidual description view 400 shows a description 402 of the “Build Web Service” action that is revealed in response to a user action. For example, the user action may include moving a cursor 404 over the node 204 associated with the action and stopping for a short period. Other visual enhancements may also be utilized.

The nodes and/or directed links can be presented with some type of visual indicator or decoration (e.g. color-codes, checkmarks) to show a state (e.g. not started, in progress, or completed) of the corresponding actions/decisions. This allows a user to readily understand what has been accomplished and what remains to be done. However, the shown state is not limited to a completion status of the action; embodiments of the invention may show any state condition (e.g. a value corresponding to the percentage of the overall project a particular action represents) which is useful to the user. The state information can be saved and carried over to the next session, so the user can resume review and/or interaction with the roadmap in the same condition at the conclusion of the previous session.

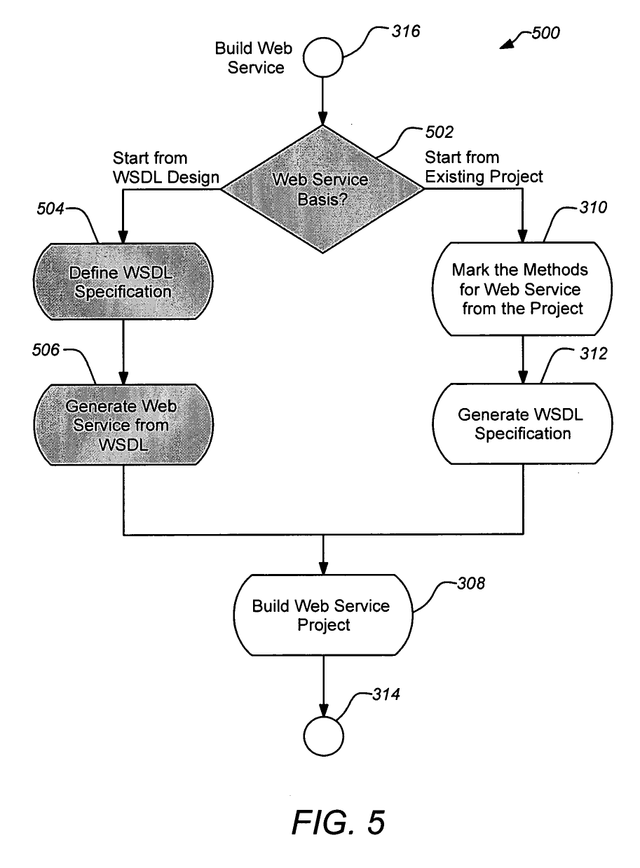

FIG. 5 illustrates a view 500 showing an example of a visual indicator or decoration showing coloring, that denotes the state of the actions. The state may comprise a completion status of the action corresponding to the particular node. The visual indicator may be a color, a pattern, a symbol, an animation or any other type of visual indicator which distingushes the corresponding node to the user. For example in this view 500, nodes 502-506 are displayed with coloring distinct from the remaining nodes 308-312 to indicate that the associated actions/decision have been completed.

Further functionality of the graphical roadmap view can be provided where the nodes and/or directed links provide some context menus wherever appropriate. These context menus may implement a wide range of functions including showing more detailed information about the corresponding action/decision, providing direction to the user of how to complete the action/decision, completing the action for the user (if the action can be automated), and allowing the user to change and/or track of the action state. (As discussed hereafter, the software application may also customize these menus to provide more application-specific menus to the user.) Thus, embodiments of the invention may include program instructions for providing context menus for performing one or more functions associated with an action.

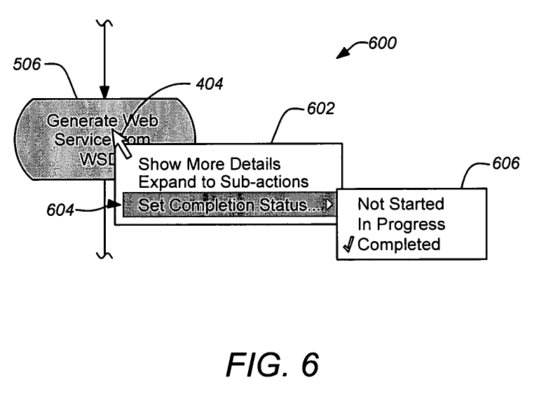

FIG. 6 shows an example of context menus provided for an action. In this example, the context menu 600 shows a list 602 of possible actions including displaying detailed information on a selected action, expanding the action to show underlying sub-actions (i.e. directing a user how to complete a selected action) and changing a completion status of a selected action. In the example, the context menu 600 is accessed by right-clicking a cursor 404 moved over the node 506 corresponding to the desired action (in this case, generating a eb service from WSDL). Also in the example, one of the menu functions allows the status indicator can be changed by left-clicking the cursor on the appropriate status in a sub-list 606 associated with the function of changing a completion status.

3. Roadmap View Component

As mentioned above, the roadmap view is implemented with a generic framework with a shareable component that can be utilized with a plurality of client software applications. It can be implemented as a standalone component which exposes a set of public interfaces to allow an independent software application to specify the roadmap and necessary customization with respect to its own requirements. In this manner, various software applications can leverage a graphical roadmap view as desired to provide users improved understanding of what is necessary to accomplish a desired activity. For example, applicable software applications can range from application development tools, computer aided design (CAD) applications, word processing and other general business applications, tax planning tools, on-line software applications (e.g. DMV registration or college application web-based applications), any multi-step request/purchase/registration/self-support/DIY-support/form-driven applications or any other software application for performing an activity comprising a plurality of actions.

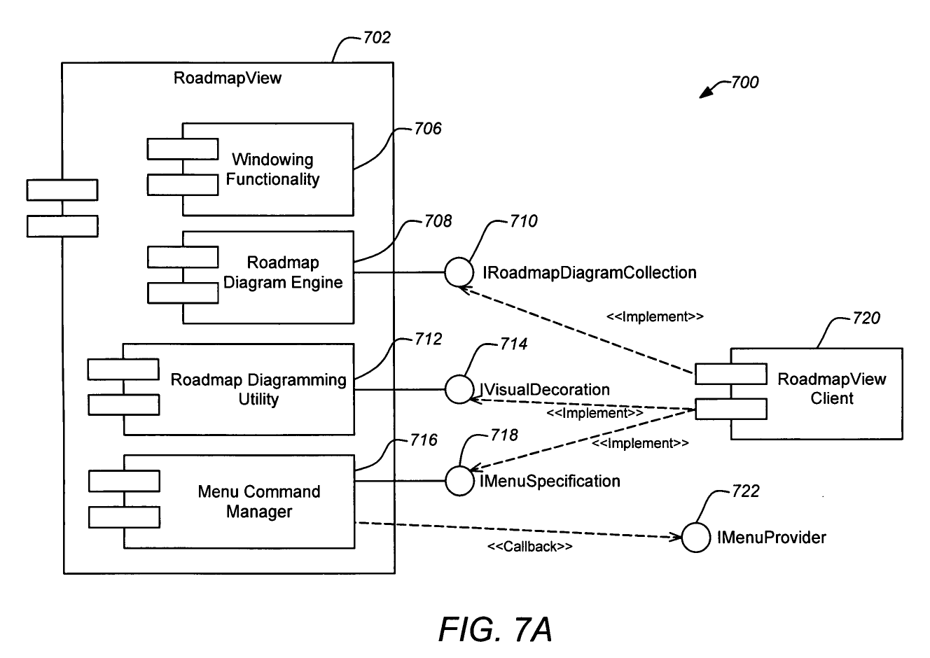

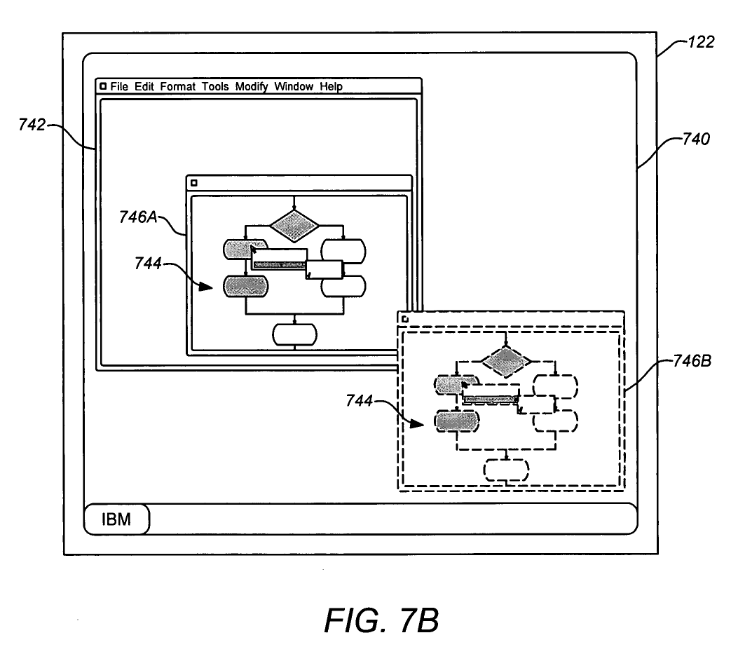

FIG. 7A illustrates an architectural view of a generic framework 700 with a shareable component 702 and how it interacts with its client 720, the application that employs the roadmap views. The client 720 may be a single software application or it may be a sub-application within a software application; there may be multiple clients 720 that utilize the shareable component within a single software application. In this context, the terms “client”, “application”, and “sub-application” are interchangeable. The roadmap view component 702 of the generic framework 700 may support a number of different subcomponents.

The Windowing Functionality subcomponent 706 implements the basic windowing operations, including the life-cycle management of the roadmap views, rendering, refreshing and/or resizing of the nodes and directed links in the views, and docking and undocking of the views with the main window of the client. The software application client 720 can instantiate the graphical roadmap view, and use its view handle to manage the one or more instances of the view.

The Roadmap Diagram Engine subcomponent 708 takes a roadmap diagram collection 710 (e.g. UML activity diagrams serialized in the XML format) from the software application client 720 and interacts with the Windows Functionality and Roadmap Diagramming Utility subcomponents 706, 712 to render the diagrams in the graphical roadmap views. Each of the nodes and directed links on those diagrams may include an associated brief individual description and a unique identifier which may also serve as references between the diagrams.

The Roadmap Diagramming Utility subcomponent 712 provides the diagramming support including default visual indicators or decorations in the diagram that shows the states of the corresponding actions for the nodes. The subcomponent 712 has a public interface for the software application client 720 to provide custom visual indicators 714 (IVisualDecoration) that override the default visual indicators residing within the component 712.

The Menu Command Manager subcomponent 716 handles the registration and enabling and disabling of the menu commands, as well as dispatching the commands to the contributing components and/or clients for the actual execution. This subcomponent 716 may also provide a few default context menus for the nodes. The software application client 720 can also contribute its own custom menu commands through IMenuSpecification interface 718, and have the Menu Command Manager subcomponent 716 call back through the IMenuProvider paired interface 722 in response to the user selecting a menu command it contributes. Therefore, if an action can be automatically carried out by the software application client 720 itself without further user action, the software application client 720 can add a menu command for it, and execute software application client 720 logic in response to the Menu Command Manager subcomponent 716 call back upon the user's invocation of the menu.

With the foregoing subcomponents in place within the shareable component 702, the generic roadmap framework 700 can be reused by several different clients 720. The specific subcomponents within the shareable component 702 are merely illustrative and may be varied and/or added to as is understood by those skilled in the art. Employing such an architecture, a software application like the J2EE development tool can use the generic framework 700, customized with J2EE-specific information, to assist a user in developing J2EE applications. Furthermore, another unrelated software application (e.g. a tax planning tool, on-line software applications) can also use the same generic framework 700, now customized with tax-specific information and functions, to assist planning and generating tax reports.

FIG. 7B illustrates a graphical roadmap view operating with a software application. In this example, the computer display 122 presents the GUI 740 which includes a main window 742 for the running software application client. The graphical roadmap view 744 is shown as a mode-less subwindow 746A that may be docked inside the main window 742 or floating as a separate window 746B (which may be positioned as desired, e.g. side-by-side with the main window 742). Alternately, the roadmap view 744 may be implemented as a modal sub-window, e.g. similar to a dialog box, wherein the roadmap view 744 is revealed in response to menu commands.

4. Roadmap View Method

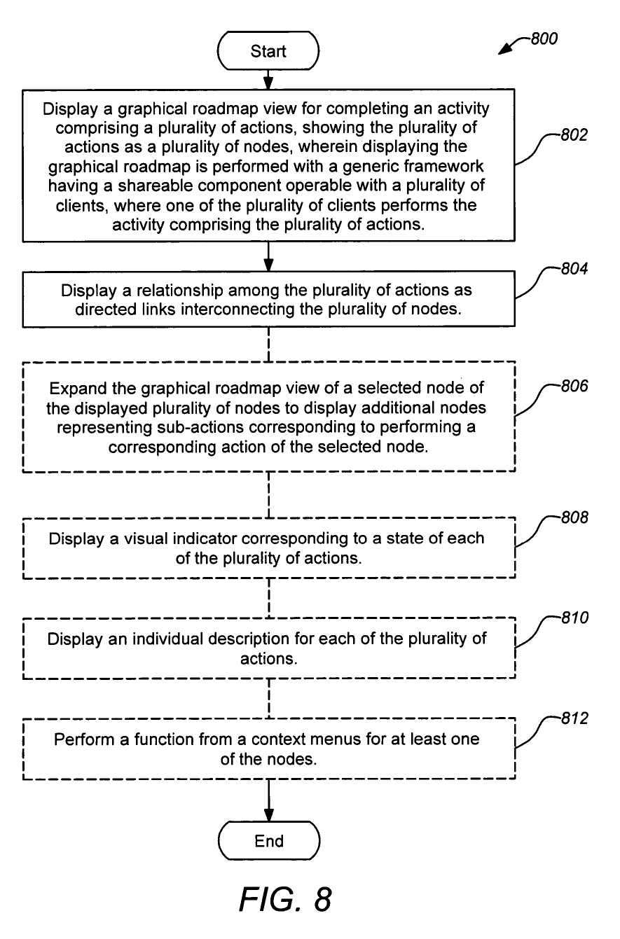

FIG. 8 is a flowchart of an exemplary method 800 of providing a graphical roadmap view. The method 800 begins with an operation 802 of displaying a graphical roadmap view for completing an activity comprising a plurality of actions, showing the plurality of actions as a plurality of nodes. Displaying the graphical roadmap is performed with a generic framework having a shareable component operable with a plurality of clients, where one of the plurality of clients performs the activity comprising the plurality of actions. In addition, operation 804 displays a relationship among the plurality of actions as directed links interconnecting the plurality of nodes. The method 800 may be further enhanced with the addition of several optional operations.

For example, the method 800 may also include operation 806 for expanding the graphical roadmap view of a selected node of the displayed plurality of nodes to display additional nodes representing sub-actions corresponding to performing a corresponding action of the selected node. Optional operation 808 displays a visual indicator corresponding to a state of each of the plurality of actions. Optional operation 810 displays an individual description for each of the plurality of actions. In addition, optional operation 812 performs a function from a context menus for at least one of the nodes. The function may be displaying detailed information on a selected action, directing a user how to complete a selected action, completing a selected action or changing a completion status of a selected action. The method 800 may be further modified consistent with the computer program embodiments described above.

This concludes the description including the preferred embodiment of the present invention. The foregoing description has been presented for the purposes of illustration and description. It is not intended to be exhaustive or to limit the invention to the precise forms disclosed. Many modifications and variations are possible within the scope of the foregoing teachings. Additional variations of the present invention may be devised without departing from the inventive concept as set forth in the following claims.

What is claimed is:

1. A computer program embodied on a computer readable medium, comprising:
program instructions for displaying a graphical roadmap view for completing an activity comprising a plurality of actions, showing the plurality of actions as a plurality of nodes; and
program instructions for displaying a relationship among the plurality of actions as directed links interconnecting the plurality of nodes;
wherein the program instructions for displaying the graphical roadmap view comprise a generic framework with a shareable component operable with a plurality of clients, where one of the plurality of clients performs the activity comprising the plurality of actions.

2. The computer program of claim 1, wherein the shareable component
a windowing functionality subcomponent for implementing windowing operations of the graphical roadmap view;
a roadmap diagram engine subcomponent for rendering diagrams in the graphical roadmap view;
a roadmap diagramming utility subcomponent for providing diagramming support including default visual indicators for the graphical roadmap view; and
a menu command manager subcomponent for registration, enabling and disabling of menu commands and communicating commands among subcomponents and the software application.

3. The computer program of claim 1, wherein the activity further comprises at least one decision point among the plurality of actions and the graphical roadmap view shows the at least one decision point as at least one decision point node interconnected with the directed links to the plurality of nodes.

4. The computer program of claim 1, further comprising program instructions for expanding the graphical roadmap view of a selected node of the displayed plurality of nodes to display additional nodes representing sub-actions corresponding to performing a corresponding action of the selected node.

5. The computer program of claim 1, further comprising program instructions for displaying a visual indicator corresponding to a state of each of the plurality of actions.

6. The computer program of claim 5, wherein the state comprises a completion status of each of the plurality of actions.

7. The computer program of claim 5, wherein the visual indicator is selected from the group consisting of a color, a pattern, a symbol, and an animation.

8. The computer program of claim 1, further comprising program instructions for displaying an individual description for each of the plurality of actions.

9. The computer program of claim 8, wherein the individual description is displayed upon selection of a corresponding node among the plurality of nodes.

10. The computer program of claim 1, further comprising program instructions for providing context menus for each of the nodes where a function of the context menus is selected from a group consisting of displaying detailed information on a selected action, directing a user how to complete a selected action, completing a selected action and changing a completion status of a selected action.

11. A method, comprising:
displaying a graphical roadmap view for completing an activity comprising a plurality of actions, showing the plurality of actions as a plurality of nodes;
displaying a relationship among the plurality of actions as directed links interconnecting the plurality of nodes;
wherein displaying the graphical roadmap is performed with a generic framework having a shareable component operable with a plurality of clients, where one of the plurality of clients performs the activity comprising the plurality of actions.

12. The method of claim 11, wherein the activity further comprises at least one decision point among the plurality of actions and the graphical roadmap view shows the at least one decision point as at least one decision point node interconnected with the directed links to the plurality of nodes.

13. The method of claim 11, further comprising expanding the graphical roadmap view of a selected node of the displayed plurality of nodes to display additional nodes representing sub-actions corresponding to performing a corresponding action of the selected node.

14. The method of claim 11, further comprising displaying a visual indicator corresponding to a state of each of the plurality of actions.

15. The method of claim 14, wherein the state comprises a completion status of each of the plurality of actions.

16. The method of claim 14, wherein the visual indicator is selected from the group consisting of a color, a pattern, a symbol, and an animation.

17. The method of claim 1 1, further comprising displaying an individual description for each of the plurality of actions.

18. The method of claim 17, wherein the individual description is displayed upon selection of a corresponding node among the plurality of nodes.

19. The method of claim 11, further comprising performing a function from a context menus for at least one of the nodes where the function is selected from a group consisting of displaying detailed information on a selected action, directing a user how to complete a selected action, completing a selected action and changing a completion status of a selected action.

20. A computer program embodied on a computer readable medium, comprising:
program instructions for displaying a graphical roadmap view for completing an activity comprising a plurality of actions showing the plurality of actions as a plurality of nodes and a relationship among the plurality of actions as directed links interconnecting the plurality of nodes;
wherein the program instructions for displaying the graphical roadmap view comprise a generic framework with a shareable component operable with a plurality of clients, the shareable component including:
a windowing functionality subcomponent for implementing windowing operations of the graphical roadmap view;
a roadmap diagram engine subcomponent for rendering diagrams in the graphical roadmap view;
a roadmap diagramming utility subcomponent for providing diagramming support including default visual indicators for the graphical roadmap view; and
a menu command manager subcomponent for registration, enabling and disabling of menu commands and communicating commands among subcomponents and an active client.
